(19) United States
(12) Patent Application Publication
(10) Pub. No.: US 2013/0290107 A1
(43) Pub. Date: Oct. 31, 2013

(54) BEHAVIOR BASED BUNDLING

(71) Applicants: Soma S. Santhiveeran, Fremont, CA (US); Walter F. Pereira, Porto Alegre (BR); Leonardo A. Machado, Porto Alegre (BR); Diogo S. de Lima, Porto Alegre (BR); Cristiane K. Wasielewski, Gravatai (BR); Leonardo Fagundes da Silva, Porto Alegre (BR)

(72) Inventors: Soma S. Santhiveeran, Fremont, CA (US); Walter F. Pereira, Porto Alegre (BR); Leonardo A. Machado, Porto Alegre (BR); Diogo S. de Lima, Porto Alegre (BR); Cristiane K. Wasielewski, Gravatai (BR); Leonardo Fagundes da Silva, Porto Alegre (BR)

(21) Appl. No.: 13/458,185

(22) Filed: Apr. 27, 2012

(51) Int. Cl. G06Q 30/02; G06K 9/46; G06Q 20/20; G06Q 30/00

(52) U.S. Cl. 705/14.65; 705/26.7; 705/14.66; 382/118

(57) ABSTRACT

According to an example, browsing behavior of an individual in a physical store can be tracked with a camera. The browsing behavior of the individual can be associated with a product in the physical store. Information related to the product based on the associated browsing behavior can be communicated to the individual.

### BACKGROUND

Individuals can purchase products via phone, mail, Internet, and/or in physical stores, for example. On-line stores that are accessible via the Internet can offer some features that are known to customers who shop in physical stores. For example, on-line stores can add cart functions, where a virtual cart holds a customer's items until the customer is ready to complete their shopping experience. However, physical stores have rarely attempted to offer features that are known to customers who shop via the Internet in on-line stores.

### BRIEF DESCRIPTION OF THE DRAWINGS

FIG. 1 illustrates a computing device for behavior based bundling according to the present disclosure.

FIG. 2 illustrates a system for behavior based bundling according to the present disclosure.

FIG. 3 is a block diagram illustrating an example of a method for behavior based bundling according to the present disclosure.

FIG. 4 is a block diagram illustrating an example of a method for behavior based bundling according to the present disclosure.

FIG. 5 is a block diagram illustrating an example of a set of instructions for behavior based bundling according to the present disclosure.

### DETAILED DESCRIPTION

The present disclosure provides methods, computer-readable media, and systems for behavior based bundling. Browsing behavior of an individual in a physical store can be tracked with a camera. The browsing behavior of the individual can be associated with a product in the physical store. Information related to the product based on the associated browsing behavior can be communicated to the individual.

On-line stores can offer a benefit to the owners and customers of the store through functionality that is not available in physical stores. For example, on-line stores can track an individual's behavior while the individual is accessing the web page associated with the online store. The individual's behavior can be used to assess the individual's interest in a product, for example.

Examples of the present disclosure can track a browsing behavior of an individual in a physical store and use the tracked behavior to offer a product to the individual to purchase. For instance, examples of the present disclosure can determine an individual's interest in a product in a physical store and bundle the product with existing items that the individual is purchasing at a point of sale (e.g., register). In addition, examples of the present disclosure can track a response provided by the individual to the product offered. For example, the response can include whether or not the individual purchased the product.

Examples of the present disclosure can determine a profile of an individual and offer products to the individual that another individual with a similar profile has expressed interest in. For example, browsing behavior of another individual and/or products purchased by another individual can be assessed and used to offer the same and/or similar products to the individual.

In the present disclosure, reference is made to the accompanying drawings that form a part hereof, and in which is shown by way of illustration how one or more examples of the disclosure can be practiced. These examples are described in sufficient detail to enable practice of the examples in this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

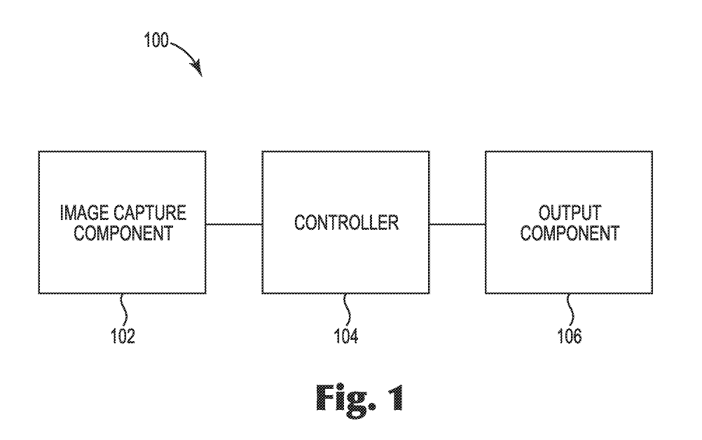

FIG. 1 illustrates a computing device for behavior based bundling according to the present disclosure. The computing device 100 can include an image capture component 102, a controller 104, and an output component 106. The image capture component 102 can be configured to capture an image of an individual browsing a product in a physical store. The product 212 can be a physical product (e.g., not a product in an advertisement). In an example, browsing can include the individual 210 looking at a product and/or handling (e.g., touching) the product 212.

The image capture component 102 can include a camera. The camera can be a video camera and/or still camera that is directed to take an image in front of the product. In an example, the camera can cover a single product (e.g., toothpaste) and/or location (e.g., store entrance), for example. In addition, the camera can be movable. For example, the camera can pan to cover an area that is in front of a different product that is located at a position to either side of the product. As such, fewer cameras can be used to cover products in the physical store.

The controller 104 can be configured to perform facial recognition on the image of the individual browsing the product to associate identity information of the individual with the image and the product. The controller 104 can create a product bundle that includes the product and the associated identity information of the individual.

The association of the identity information with the product in the browsing repository can be based on a time spent by the individual browsing the product. In an example, the individual may have to browse the product for a threshold time for the association to be made between the identity information and the product. In an example, a threshold time of 30 seconds can be set for a time that the individual has to browse the product for.

For instance, an entry-time can be recorded for when the individual enters a frame of the camera and an exit-time can be recorded for when the individual leaves the frame of the camera. Accordingly, the time between the entry-time and the exit-time can be recorded, which can indicate the time that the individual has browsed the product for.

Alternatively, the time that the individual has browsed the product for can be determined by detecting a pose of the individual's face to determine when the individual is looking at the product. For example, a time can be recorded for a period that the individual possesses a frontal pose and/or a pose that is within a threshold variation from the frontal pose (e.g., 10 degrees from a frontal pose). Alternatively, the time that the individual has browsed the product for can be determined by detecting eye movement of the individual and recording a time for a period that the individual is looking at the product.

In an example, the product can be identified through the location of the camera, a product identification on the product, and/or a visual identification of the product. For instance, the product can be identified by mounting the camera at a location that is proximate to the product. If an individual comes into a field of view of the camera, the camera can perform facial recognition (e.g., indicating the individual is looking in the direction of the camera at the product) and/or can detect eye movement to determine that the individual is looking at the product proximate to the camera. The location of the camera can then be associated with the location of the product, thus providing an identification of what product the individual is looking at.

In an example, the product can be identified through reading a product identification located on the product. For example, the product identification can include a quick response code and/or bar code that can be read by the camera. For instance, the camera can read the product identification when the individual picks up the product. In an example, a second camera can also be mounted at a second position to overlook the individual and the product. As such, the second camera can read the product identification.

In an example, the product can be identified by recognizing a visual identification of the product. For instance, the visual identification can be associated with unique product characteristics, such as a logo, color, shape, and/or size. As discussed herein, the visual identification can be recognized in an image that can be taken by the camera when the individual picks up the product and/or by a second camera that can be mounted to overlook the individual and the product.

The output component 106 can be configured to present the product bundle to the individual at a point of sale in the physical store. The point of sale can be a register, for example. In an example, the product bundle can be presented to the individual on a display located proximate to the point of sale while the individual is completing a transaction to buy other products from the physical store.

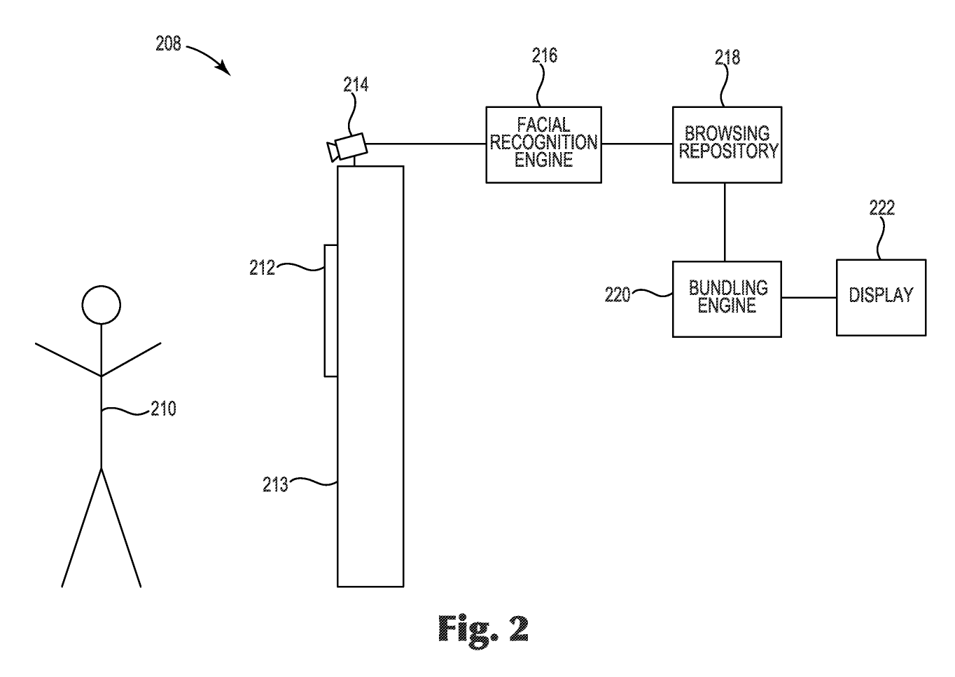

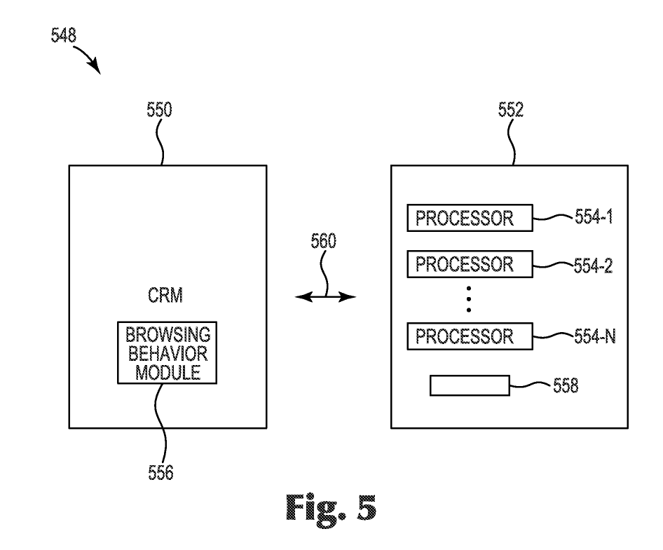

FIG. 2 illustrates a system 208 for behavior based bundling according to the present disclosure. The system 208 includes a camera 214, facial recognition engine 216, browsing repository 218, bundling engine 220, and a display 222. Some and/or all of the components of the system 208 (e.g., facial recognition engine 216, browsing repository 218, bundling engine 220, and display 222) can be located on a single computing device, further described in relation to FIG. 5. Alternatively, some and/or all of the components of the system can be located on different computing devices.

The camera 214, in the system 208, can capture an image of an individual 210 browsing a product 212 on a product rack 213 in a physical store. The camera can be located proximate to the product 212, product rack 213, can be integrated in a display that displays an advertisement associated with the product and/or another product, and/or can be located proximate to the display that displays the advertisement.

The system can perform, with a facial recognition engine 216, facial recognition on a face in the image captured by the camera 214 to associate identity information with the individual 210 in the image. In an example, the identity information can include, for example, feature points, a signature created from the feature points, and/or a name of the individual 210. Feature points can include the individual's facial features (e.g., mouth, eyes, nose, eyebrows etc.). The facial recognition engine can use the feature points to create a signature that uniquely identifies the individual's face.

In some examples, the system can compare the signature and/or feature points to the signature and/or feature points associated with images that are stored in a facial identification repository, although not shown in FIG. 2. The images that are stored in the facial identification repository can have identity information that has been previously associated with them. Upon comparison of the feature points and/or signatures between the image captured by the camera 214 and the image stored in the facial identification repository, a determination of whether a match exists between the images can be made.

Alternatively, if an image does not exist in the facial identification repository that matches the image captured by the camera 214, a new record can be created in the facial identification repository. The record can include the feature points, the signature, and/or the image captured by the camera 214. In an example, the image is not required to be stored in the facial identification repository in the interest of protecting the individual's privacy. As discussed herein, the identity of the individual 210 in the image can be associated at a point of sale.

The system 208 can include a browsing repository 218, which can store an association of the identity information with the product 212. In an example, the identity information can be associated with the product 212 that the individual 210 has browsed. For instance, if an individual 210 is browsing an electric razor, the individual's identity information can be associated with the electric razor in a browsing record stored in the browsing repository 218.

The system 208 can include a bundling engine 220 that can create a product bundle that includes the product 212 and the associated identity information of the individual 210. The bundling engine 220 can extract a browsing record from the browsing repository 218 that includes the identification information and the product 212 that has been browsed by the individual 210. In an example, the bundling engine 220 can create a list of products browsed by the individual 210, which can represent products that the individual 210 may be interested in.

The list can also include a time that the individual 210 spent browsing each product (e.g., the time that the individual spent in front of each product), which can indicate a level of interest that the individual 210 has in each product. For example, as discussed here, products that the individual 210 has browsed for a threshold time can be included on the list.

In an example, all of the products on the list can be included in the product bundle and/or a predetermined number of products can be included in the product bundle. Alternatively, products on the list that were viewed for the threshold time can be included on the list and/or products that the individual browsed for the longest time can be included on the list. Including products that the individual 210 has browsed for the longest time on the list can increase the chances that the individual 210 will buy the product, because the individual 210 has demonstrated an interest in the product (e.g., they have browsed the product for a longer time than other products).

The product bundle can be presented to the individual 210 at a point of sale in the physical store. The point of sale can be a register, for example. In an example, the product bundle can be presented to the individual on a display 222 located proximate to the point of sale while the individual 210 is completing a transaction to buy other products from the physical store. For example, the display 222 can be directed toward the individual 210 and/or the display 222 can be directed toward a sales associate, so the sales associate can read an offer associated with the product 212 to the individual 210.

A second camera can be placed proximate to the point of sale to identify the individual through facial recognition so the proper product bundle can be attained. For example, as discussed herein, feature points can be extracted from the face of the individual 210 from the image taken by the second camera and matched with the feature points and/or signature in the image captured by the camera 214.

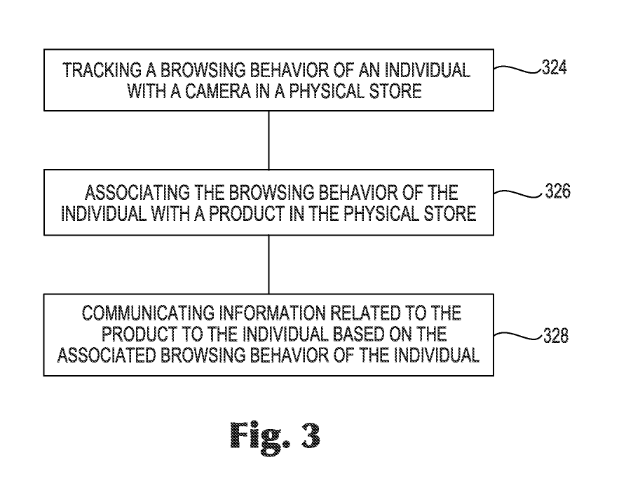

FIG. 3 is a block diagram illustrating an example of a method for behavior based bundling according to the present disclosure. The method can include tracking 324 a browsing behavior of an individual with a camera in a physical store. In an example, the camera can be located proximate to the product (e.g., on a product rack) and can record images of an area in front of the product. Alternatively, the camera can be mounted on a wall and/or ceiling, for example, and can record images of the product and/or areas surrounding the product.

As discussed herein, the camera can capture an image and/or set of images of an individual that is browsing the product. Based on the image and/or set of images, the individual can be identified. For example, feature points of the individual's face can be extracted from the image captured from the camera through facial recognition. The individual can then be identified based on the extracted feature points. For instance, the feature points can be used to create a signature that uniquely identifies the individual.

In addition, the individual's interest in the product can be determined based on the image and/or set of images captured by the camera. For example, the individual's interest in the product can be determined based on a time that the individual has viewed the product, as discussed herein.

The method can include associating 326 the browsing behavior of the individual with the product in the physical store. In an example, associating the browsing behavior with the product in the physical store can include associating the image of the individual that is browsing the product, along with the time that the individual has browsed the product with an identification of the product. As discussed herein, the product can be identified through the location of the camera, a product identification on the product, and/or a visual identification of the product.

The method can include associating the individual's identification with the browsing behavior. In an example, the feature points and/or signature that are identified and/or created through facial recognition can be associated with the time that the individual has viewed the product and an identification of the product. For instance, a list can be created that bundles an item that an individual has browsed and the associated time that the individual has browsed the product.

The method can include detecting a facial expression of the individual. For example, the feature points can be used to detect the mouth of the individual and determine whether the individual is smiling and/or frowning. When the individual is smiling, the method can include indicating that the individual is interested in the product. Alternatively, when the individual is frowning, the method can include indicating that the individual is not interested in the product.

The method can include communicating 328 information related to the product to the individual based on the associated browsing behavior of the individual. Communicating information related to the product can include displaying an offer to buy the product to the individual. In an example, the information can be communicated to the individual at a point of sale through a display. For instance, as the individual is proceeding to check out from the physical store at the point of sale, the bundled item can be displayed on a display that is located proximate to the point of sale, for example. Alternatively, the offer can be communicated to the individual through a display, located proximate to the product, which can provide the same functionality as the display located proximate to the point of sale.

In an example, the method can include identifying the individual at the point of sale. For example, a second camera can be placed proximate to the point of sale to capture an image of the individual. As discussed herein, feature points can be extracted from the image captured by the second camera and used to identify the individual.

Upon identifying the individual, the individual's browsing behavior can be retrieved based on the individual's identification. For example, the individual's identification can be matched with the individual's identification that has been associated with the browsing behavior.

The method can include providing an offer to the individual to add the product to a transaction made at the point of sale. For example, the product can be displayed on the display with an offer to purchase the product, either by notifying a sales associate and/or through an interface on the display (e.g., accepting the offer to purchase the product by selecting an icon on the display). In some examples, the product and/or group of products that the individual browsed can be offered to the individual for purchase at a discounted price.

Alternatively, the information related to the product can be communicated to the individual through other media. In an example, the information can be communicated to the individual by printing the information on a receipt that the individual is issued upon purchasing other products from the physical store. For instance, the individual can then return to the physical store with the receipt, which includes the product and/or group of products that have been bundled, which can be offered to the individual at a discounted price, in some examples. Alternatively, the individual can enter a transaction code associated with the product and/or group of products that have been bundled into an input field on a web site and/or scan a bar code and/or quick response code with a mobile device to purchase the bundled products via the Internet.

In addition, the information related to the product can be communicated to the individual's mobile device (e.g., cell phone) upon the individual providing the sales associate with their mobile number. For example, an offer to purchase the product in the physical store and/or online store at a discounted price can be communicated to the individual's mobile device.

The method can include storing a response from the individual to the offer provided to add the product to the transaction. In an example, whether or not the individual accepted the offer to purchase the product can be stored. This information can then be used to analyze sales of products that have been offered to individuals for purchase according to examples of the present disclosure.

The method can include tracking a browsing behavior of a group of individuals (e.g., a family, couple). Information associated with a product that has been browsed by the group of individuals can then be communicated to the individuals and/or an offer to purchase the product can be communicated to the individuals.

The method can include determining characteristics of the individual using the image captured by the camera. The characteristics can include, for example, age, gender, ethnicity, skin-color, height, and/or weight of the individual, although examples are not so limited. Characteristics of the individual can be determined through analysis of the image captured by the camera, in an example.

The characteristics can be associated with the browsing behavior of the individual and a profile can be created based on the characteristics and browsing behavior. In an example, the profile can be used to communicate information related to the product to a second individual based on the determined characteristics of the individual that are included in the profile. For instance, the profiles of the second individual may share common characteristics with the profile of the individual. Based on the common characteristics, the bundled products offered to the individual can be offered to the second individual.

In an example, the method can include determining items that the individual may be interested in by tracking products that have been previously purchased by the individual at the point of sale. For example, the camera located proximate to the point of sale can capture the image of the individual for identification purposes. Information regarding products that the individual is purchasing can be received from, for example, a bar code scanner at the point of sale and associated with the individual's identity. As such, products that are similar to those products purchased and/or complementary to those items purchased can be offered to the individual for purchase and/or offered to the individual for purchase at a discounted price. For example, if the individual purchases a razor, a complementary item such as shaving cream can be offered to the individual for a discounted price.

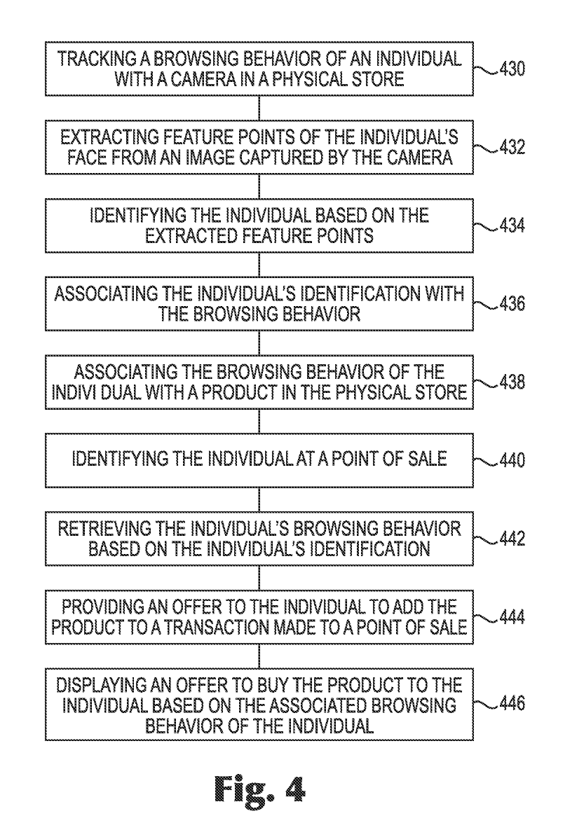

FIG. 4 is a block diagram illustrating an example of a method for behavior based bundling according to the present disclosure. The method can include tracking 430 a browsing behavior of an individual with a camera in a physical store. The camera can take an image of the individual, which can be used for extracting 432 feature points of the individual's face from the image captured by the camera. Based on the extracted feature points, the method can include identifying 434 the individual.

The method can include associating 436 the individual's identification with the browsing behavior of the individual. In an example, associating the individual's identification with the browsing behavior of the individual can include associating the individual's identification with the image of the individual, for example. The method can include associating 438 the browsing behavior of the individual with a product in the physical store.

The method can include identifying 440 the individual at a point of sale. For example, the point of sale can be a register where the individual can purchase products from the store. Based on the individual's identification, the method can include retrieving 442 the individual's browsing behavior.

The method can include providing 444 an offer to the individual to add the product to a transaction made at a point of sale. In an example, the method can include displaying 446 an offer to buy the product to the individual based on the associated browsing behavior of the individual.

FIG. 5 illustrates a block diagram 548 of an example of a computer-readable medium in communication with memory resources and processing resources for behavior based bundling according to the present disclosure. Computer-readable medium (CRM) 550 can be in communication with a computing device 552 having processor resources of more or fewer than 554-1, 554-2, . . . , 554-N, that can be in communication with, and/or receive a tangible non-transitory CRM 550 storing a browsing behavior module 556 that can contain a set of computer-readable instructions executable by one or more of the processor resources (e.g., 554-1, 554-2, . . . , 554-N) for behavior based bundling. The computing device 552 may include memory resources 558, and the processor resources 554-1, 554-2, . . . , 554-N may be coupled to the memory resources 558.

Browsing behavior module 556 can contain computer-executable instructions executed by the processor resources 554-1, 554-2, . . . , 554-N for behavior based bundling. The instructions can be stored on an internal or external non-transitory CRM 550. The browsing behavior module 556 can contain computer-executable instructions executed by the processor resources 554-1, 554-2, . . . , 554-N to capture an image of an individual that is browsing a product in a physical store. Further, the browsing behavior module 556 can contain computer-executable instructions executed by the processor resources 554-1, 554-2, . . . , 554-N to detect a face of the individual from the image. The browsing behavior module 556 can contain computer-executable instructions executed by the processor resources 554-1, 554-2, . . . , 554-N to perform facial recognition on the face of the individual to identify the individual. For example, feature points can be extracted from the face of the individual from the image and can be used to create a signature.

In an example, a profile of the individual can be determined through analysis of the image captured by the camera. The profile can be used to provide an offer provided to the individual to a second individual based on the profile of the individual and the second individual. For example, if the individual and the second individual share common characteristics in their profiles, a determination can be made that the second individual may be interested in a product browsed by the individual. As discussed herein, the profile can include characteristics such as, for example, age, gender, ethnicity, skin-color, height, and/or weight of the individual and can be determined through face analysis of the face in the image captured by the camera and/or analysis of an individual's body in the image (e.g., to determine height and/or weight).

When the camera is a still camera, the profile of the individual can be determined more easily than when the camera is a video camera, due to the increase in frames taken by the video camera, for example. Examples of the present disclosure can improve an accuracy of face analysis to provide a more accurate profile of the individual. For example, instructions can be executed to calculate a quality score for the detected face of the individual in the image based on a visibility of the face, angle of the face, size of the face, and/or blur of the face. The quality score can measure a suitability of the image of the face for face analysis. In an example, a quality score of 0 to 208 can be given for the image of the face, wherein a quality score of 208 means that face analysis will work 208 percent of the time (e.g., characteristics of the individual can be determined).

When the profile of the individual does not exist (e.g., a profile has not been stored for the individual), a profile of the individual can be determined when the quality score is above a quality threshold. In an example, the quality threshold can be set at a value where a face analysis can be performed reliability a majority of the time. When the quality score for the detected face of the individual is above the threshold, face analysis can be performed to determine characteristics of the individual, such as, age, gender, ethnicity, skin-color, height, and/or weight, for example. Results of the face analysis can be tagged to the image of the face along with the quality score.

Alternatively, when the profile of the individual exists, the profile can be updated when the quality score exceeds a quality score for a previously detected face of the individual. When the quality score for the previously detected face of the individual is higher, the profile can be left as is and no updates can be performed.

For example, the profile can be updated when a quality score for the previously detected face of the individual is 55 and the new quality score is 65. In some examples, the profile can be updated when the quality score is greater than the quality score for the previously detected face by a predetermined threshold. When the quality score exceeds the quality score for the previously detected face of the individual, face analysis can be performed and new tags associated with the characteristics of the individual can replace old tags, tagging the image of the face with the new tags and/or the quality score.

In an example, instructions can be executed to provide the offer to a second individual based on the profile of the individual and the profile of the second individual. The accuracy of the profile of the individual and/or the second individual can be improved by updating the quality score and tags associated with the face of the individual and/or second individual in the image. As a result, the accuracy in matching the profile between the individual and the second individual can be improved along with a probability that the second individual will be interested in the offer provided to the individual.

The browsing behavior module 556 can contain computer-executable instructions executed by the processor resources 554-1, 554-2, . . . , 554-N to associate the individual's identity with the product. For example, feature points and/or the signature associated with the face in the image captured by the camera can be associated with the product. As such, when an individual checks out of the store, a second camera can capture an image of the individual's face and feature points can be extracted from the image and used to create a signature, which can be matched with the existing feature points and/or signature. If a match exists between the feature points and/or signature, the computer-readable instructions can be executed to provide an offer to the individual to purchase the product, as discussed herein.

A non-transitory CRM (e.g., 550), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

The non-transitory CRM 550 can be integral, or communicatively coupled, to a computing device, in either a wired or wireless manner. For example, the non-transitory CRM can be an internal memory, a portable memory, a portable disk, or a memory located internal to another computing resource (e.g., enabling the computer-executable instructions to be downloaded over the Internet).

The CRM 550 can be in communication with the processor resources (e.g., 554-1, 554-2, . . . , 554-N) via a communication path 560. The communication path 560 can be local or remote to a machine associated with the processor resources 554-1, 554-2, . . . , 554-N. Examples of a local communication path 560 can include an electronic bus internal to a machine such as a computer where the CRM 550 is one of volatile, non-volatile, fixed, and/or removable storage medium in communication with the processor resources (e.g., 554-1, 554-2, . . . , 554-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 560 can be such that the CRM 550 is remote from the processor resources (e.g., 554-1, 554-2, . . . , 554-N) such as in the example of a network connection between the CRM 550 and the processor resources (e.g., 554-1, 554-2, . . . , 554-N). That is, the communication path 560 can be a network connection. Examples of such a network connection can include a local area network (LAN), a wide area network (WAN), a personal area network (PAN), and the Internet, among others. In such examples, the CRM 550 may be associated with a first computing device and the processor resources (e.g., 554-1, 554-2, . . . , 554-N) may be associated with a second computing device.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

The term “a number of” is meant to be understood as including at least one but not limited to one.

1. A method for behavior based bundling, comprising;
tracking a browsing behavior of an individual with a camera in a physical store, wherein the browsing behavior of the individual is based on a pose of a face of the individual;
associating the browsing behavior of the individual with a product in the physical store; and
communicating information related to the product to the individual based on the associated browsing behavior of the individual.

2. The method of claim 1, wherein communicating information related to the product includes displaying an offer to buy the product to the individual.

3. The method of claim 1, wherein the method includes:
extracting feature points of the individual's face from an image captured by the camera;
identifying the individual based on the extracted feature points; and
associating the individual's identification with the browsing behavior.

4. The method of claim 3, wherein the method includes:
identifying the individual at a point of sale;
retrieving the individual's browsing behavior based on the individual's identification; and
providing an offer to the individual to add the product to a transaction made at a point of sale.

5. The method of claim 4, wherein the method includes storing a response from the individual to the offer provided to add the product to the transaction.

6. The method of claim 1, wherein the method includes determining characteristics of the individual using an image captured by the camera, wherein the characteristics include at least one of an age, gender, ethnicity, skin-color, height, and weight of the individual.

7. The method of claim 6, wherein the method includes communicating information related to the product to a second individual based on the determined characteristics of the individual.

8. A non-transitory computer-readable medium storing instructions for behavior based bundling executable by a computer to cause the computer to:
capture an image of an individual that is browsing a product in a physical store;
detect a face of the individual from the image;
perform facial recognition on the face of the individual to identify the individual;
associate the individual's identity with the product, wherein the association is based on a detection of eye movement of the individual; and
provide an offer to the individual to purchase the product.

9. The computer-readable medium of claim 8, wherein the instructions include instructions to calculate a quality score for the detected face of the individual based on at least one of a visibility of the face, angle of the face, size of the face, and blur of the face.

10. The computer-readable medium of claim 9, wherein the instructions include instructions to:
determine a profile of the individual when the profile of the individual does not exist and the quality score is above a quality threshold; and
update the profile of the individual when the quality score exceeds a quality score for a previously detected face of the individual.

11. The computer-readable medium of claim 10, wherein the instructions include instructions to provide the offer to a second individual based on the profile of the individual and a profile of the second individual.

12. A computing device for behavior based bundling, comprising:
an image capture component configured to capture an image of an individual browsing a product in a physical store;
a controller configured to perform facial recognition on the image of the individual browsing the product to associate identity information of the individual with the image and the product, wherein the controller creates a product bundle that includes the product and the associated identity information of the individual, and wherein the associated identity information is based on a pose of a face of the individual; and
an output component configured to present the product bundle to the individual at a point of sale in the physical store.

13. The system of claim 12, wherein the association of the identity information with the product is based on a time spent by the individual browsing the product.

14. The system of claim 12, wherein an identification of the product is determined through at least one of a location of the camera, a product identification on the product, and a visual identification of the product.

15. The system of claim 12, wherein the product bundle is displayed to the individual on a display located proximate to the point of sale.
